(19) United States
(12) Patent Application Publication
(10) Pub. No.: US 2013/0103487 A1
(43) Pub. Date: Apr. 25, 2013

(54) SMART CARD WITH PRODUCT SUBSTANTIATION SYSTEM AND METHOD

(71) Applicants: Barry J. Nordstrand, Excelsior, MN (US); Kari B. Hawkins, Medicine Lake, MN (US)

(72) Inventors: Barry J. Nordstrand, Excelsior, MN (US); Kari B. Hawkins, Medicine Lake, MN (US)

(73) Assignee: SOLUTRAN, Minneapolis, MN (US)

(21) Appl. No.: 13/446,743

(22) Filed: Apr. 13, 2012

Related U.S. Application Data
(60) Provisional application No. 61/475,993, filed on Apr. 15, 2011.

(51) Int. Cl. G06Q 20/34

(52) U.S. Cl. CPC G06Q 20/341; G06Q 30/0238
USPC 705/14.38

(57) ABSTRACT

A system and method is presented for using smart cards to provide promotions to consumers. Data on the card is combined with an approved product list, such as that provided in WIC embodiments, to provide both promotional details and track usage by the user.

### RELATED APPLICATIONS

The present application claims the benefit of U.S. Provisional Application No. 61/475,993, filed Apr. 15, 2011.

### FIELD OF THE INVENTION

The present application relates to the field of smart cards. More particularly, the described embodiments relate to a system and method in which smart cards designed for use in implementation of WIC (Women, Infants & Children) programs are further used in the implementation of promotional offers.

### BRIEF DESCRIPTION OF THE DRAWINGS

FIG. 1 is a system diagram showing the primary components of one embodiment of the present invention.

FIG. 2 is a table showing pricing types and their descriptions.

FIG. 3 is a block diagram showing the relationship between smart card data and a first set of APL data.

FIG. 4 is a block diagram showing the relationship between smart card data and a second set of APL data.

FIG. 6 is a flow chart showing the relationships between data in a second embodiment.

FIG. 7 is a block diagram showing the major components of one embodiment of the present invention.

### DETAILED DESCRIPTION

### Overview

The present invention involves a new processing technique for smart cards. The preferred embodiment is enabled by a platform created by the assignee of the present invention, which is called the Solutran Super Smart Card Platform (or “S3”). The technique for processing transactions on this system involves a number of components including a smart card, data and programming loaded into the smart card, a retailer Point-of-Sale system (POS), a smart card reader, a retailer Electronic Cash Register (ECR), a software program in the retailer's centralized store server, a file exchange between the retailer and the processor and a funds settlement protocol.

The foundation for this process is the current Women, Infants and Children's Electronic Benefit Transfer process (WIC EBT). This process was developed by the USDA's Food Nutrition Service in conjunction with the State of Texas, the State of New Mexico and the State of Wyoming. Details of this process can be found in the “Texas Department of Health Specification for Integrated WIC EBT Grocer Systems,” Version 1.5, Apr. 9, 2004 (which is hereby incorporated in its entirety).

The S3 platform will be used to drive a number of consumer incentive and benefit distribution programs. S3 smart cards will be distributed to cardholders, which can be used at participating retail locations. After inserting their S3 card into the retailer's smart card reader, users will be prompted to enter a Personal Identification Number (PIN). Once validated, incentives such as product discounts and free product samples will be made available to cardholders. Discount types, quantities, expiration dates and maximum spending limits will all be controlled by the S3 platform.

### System Configuration

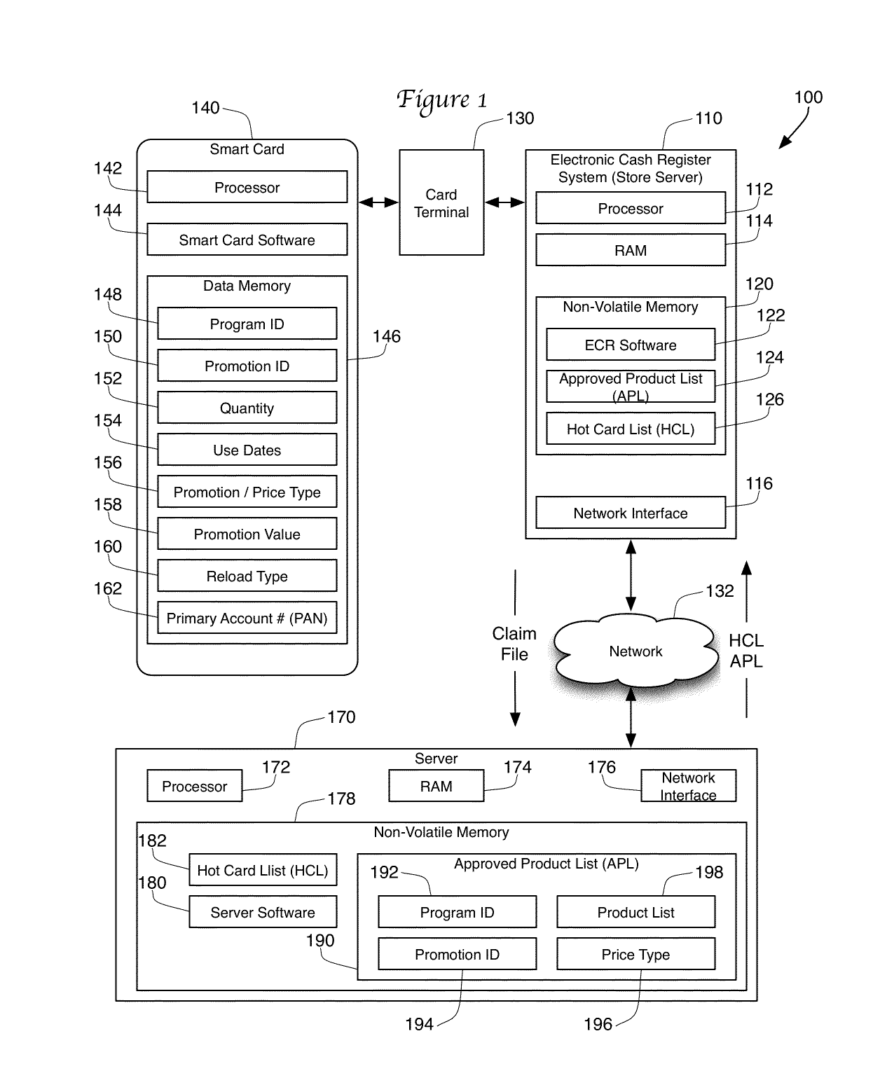

FIG. 1 shows a system 100 implementing one embodiment of the present invention. A point of sale or electronic cash register (POS/ECR) computer system 110 is provided to process items provided for purchase by a consumer. The POS/ECR system 110 preferably includes a set of software instructions or interfaces 122 stored on a non-volatile, non-transitory, computer readable medium 120 such as a hard drive or flash memory device. The software instructions 122 inform the POS/ECR system 110 how to perform the methods of the present invention, including the identification of S3 cards, the identification of promotion types, the identification of promotion quantities, the calculation of transaction discounts, the updating of S3 smart cards for correct promotion quantities and the generation of claims for funds settlement.

A digital processor 112 in the POS/ECR system 110, such as a general purpose CPU manufactured by Intel Corporation (Mountain View, Calif.) or Advanced Micro Devices, Inc. (Sunnyvale, Calif.) accesses and performs the software 122. To improve efficiency, the processor 112 may load software 122 stored in non-transitory memory 120 into faster but volatile RAM 114. Data operated upon by the software 122 can also be stored in non-volatile memory 120 and retrieved into RAM 114 for analysis, recording, and reporting. Data relevant to the disclosed embodiments of the present invention are an approved product list (or APL) 124 and a hot card list (or HCL) 126. The POS/ECR system 110 preferably further includes a network interface 116 to communicate with other computerized devices across a digital data network 130. In one embodiment, the network 130 is the Internet, and the network interface 116 includes TCP/IP protocol stacks for communicating over the network 132. The network interface 116 may connect to the network 132 wirelessly or through a physical wired connection. Instead of being a single device with a single processor, the POS/ECR system 110 could also implemented using a network of devices all operating according to the instructions of the software, or a network of independent devices communicating with a server. In one embodiment, a retailer implements the ECR system 110 as a plurality of electronic cash registers at each checkout lane, with each electronic cash register in communication with a central server physically located in the back office of the retailer's store location.

The POS/ECR system 110 is in electrical connection with a scanner or terminal 130. This scanner 130 is designed to read data off of a smart card 140. The smart card 140 itself contains a processor 142 and smart card software 144 that operates on the processor 142. In addition, the smart card 140 contains a physical, non-volatile memory 146 that contains data 148-162 that is stored on and manipulated by the smart card 140. The software 144 can be stored on the same memory device 146 as the data, or can be stored in some other physical, computer readable storage medium. The data 148-162 contains promotional values specific to each consumer and tells the POS/ECR system 110 how to reduce the purchase price for specific products in the checkout basket. The scanner 510 can read this card data off of the card 140, and provides the data to the POS/ECR system 110. This information is compared to hot card list or HCL 126 for authentication of the smart card 140 and compared to the approved product list or APL 124 to allow and compute product promotions.

The POS/ECR system 110 communicates over the network 132 with a central server computer 170. The primary purpose of the communication is to upload claim files from the ECR system 110 to the server 170, and to download APL 124 and HCL 126 information from the server 170 to the ECR system 110. In one embodiment, the APL 124 is downloaded to retailers each night and contains information on the currently running promotions and the qualifying products via specific product identifiers (UPC's and PLU's). The APL information 124 is correlated with the smart card data 148-162 to inform the ECR system 110 which individual products are allowed a promotion and the rules for that promotion. The POS/ECR system 110 can then determine the extent to which the consumer has utilized those promotions by examining the data on the smart card 140. By changing the APL 124 stored on the ECR system 110 frequently, the promotions can be frequently changed without having to reprogram the data on the smart card 140. By using a smart card 140 instead of a “dumb” identification card, prior usage of promotions can be tracked inside the card 140 to ensure that users to not exceed limits placed on the promotion.

Like the ECR system 110, the server computer 170 has a processor 172 to perform programming instructions, RAM 174 to speed up the handling of instructions and data, a network interface to allow communication with other computerized devices (such as ECR system 110) over the network), and tangible, non-volatile, computer-readable memory 178 such as a hard drive or flash memory. The memory 178 contains the server software 180 that operates on the processor 172 and performs the computer-implemented methods described below. The server 170 also maintains on memory 178 a hot card list or HCL 182 that identifies smart cards (such as card 140) that are no longer valid. By maintaining a central list of card identifiers that have been lost, stolen, or otherwise inactivated in the HCL 182, this information can be shared frequently with a variety of retailers in order to prevent fraudulent or otherwise inappropriate use of smart cards 140. The server 170 also maintains an approved product list or APL 190. In the preferred embodiment, the APL itself contains four types of information, namely a product identifier 192, a promotion identifier 194, a price type 196, and a product list 198. This information is regularly shared with ECR systems 110 of various retailers in order for the ECR software 122 to properly allow promotions under the system 100. By regularly updating the APL 124 stored at a retail location through downloads from the APL 190 stored at a central server 170, changes to the promotions can be centrally made and downloaded frequently to individual retail locations. In the preferred embodiment, separate APLs 190 can be created at maintained at the server 170 for different retailers. The particular APL 190 downloaded to an ECR 110 will then be determined based upon the retailer and location of the ECR 110 receiving the data.

### S3 Platform Structure—Data Used

The S3 platform design is flexible to accommodate many program designs. In order to understand how programs can be structured, it is important to understand three elements: i) the information stored on the card; ii) the information stored in the Approved Product List (APL); and iii) the information stored in the retailer Electronic Cash Register system (ECR).

### Information Stored on the Card

Each S3 smart card 140 contains a smart chip including a processor 142. The card includes application software 144 that manages card information and interoperability with the ECR 110. Information regarding each promotion is also preloaded onto cards 140. Certain key data elements drive card functionality and are listed below:
Program ID 148—Each card program gets a program ID.
Promotion ID 150—Inside each program is multiple promotions. These promotions could be currently in use or reserved for future use. Each program can hold 99 promotions.
Quantity 152—Quantity of benefits cardholder can receive for each promotion. Value is stored as a number and can refer to either dollar ($) amounts or number of product units. Each promotion can hold up to 999 units.
Benefit Start 154—First date that promotion benefits are available to cardholder
Benefit End 154—Last date that promotion benefits are available to cardholder (the benefit start and end information is shown combined as use dates 154 in FIG. 1)
Promotion Type 156—A description of each promotion. Available Types include:
   Discount Percentage (%)
   Discount Dollar Amount ($)
   Free item
   Buy-One-Get-One-Free
Promotion Value 158—A value associated with each Promotion Type. This value could describe the number of percent or dollar amount discounted.

Each S3 smart card 140 also includes reload type information 160 that controls when promotions defined by data items 148-158 can be reloaded on the card 140. In addition, the card 140 uses a primary account number or PAN 162 to identify the card account number.

### Information Stored in the Approved Product List (APL)

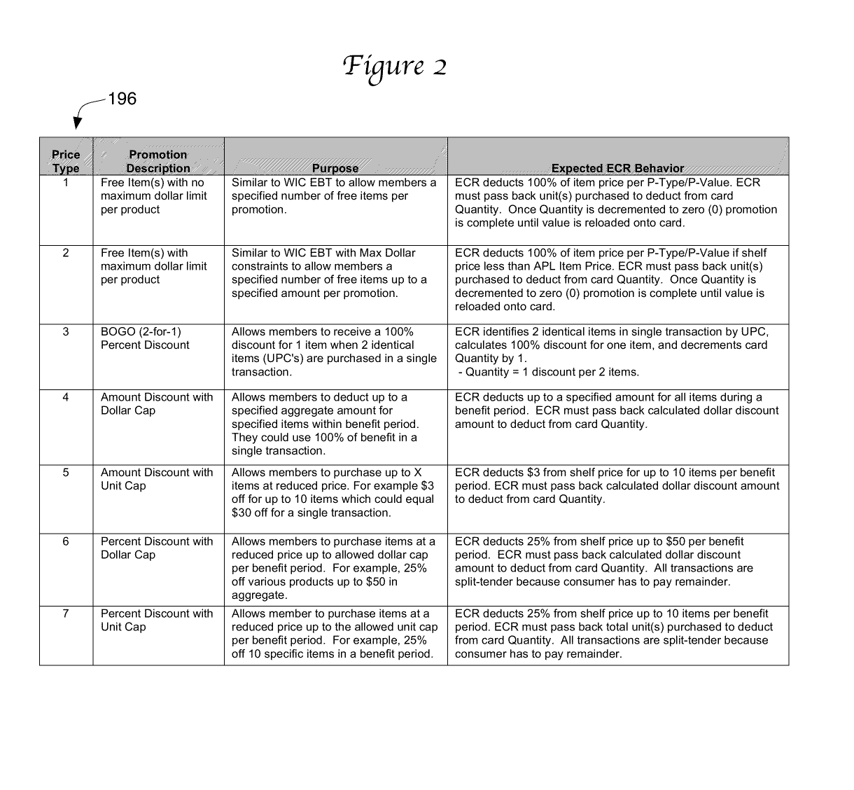

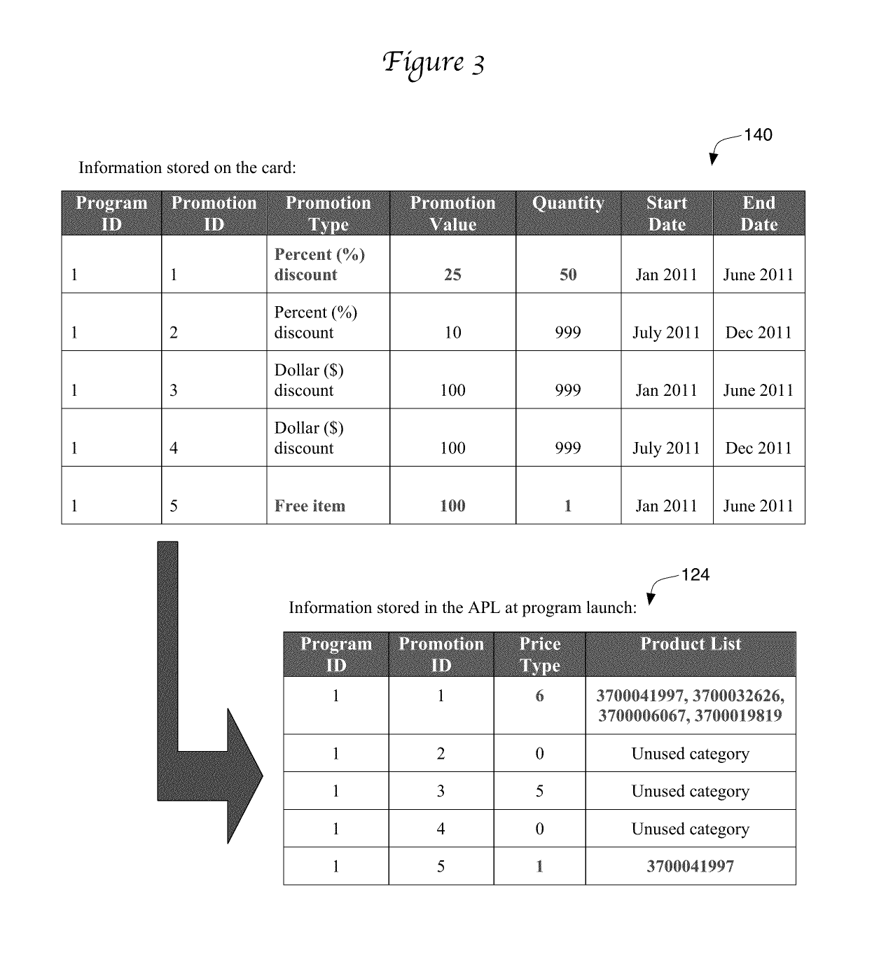

The server 170 will transmit an Approved Product List (APL) 190 to participating retailers. The APL 190 (item 124 when stored on the ECR 110) contains detailed information regarding specific product promotions. A few data elements are the same as the items listed above in “Information stored in the card,” and are used to map card elements to APL data. The APL 190 contains specific UPC or other product codes that determine specific program functionality. Key data elements in the APL 190 include:
Program ID 192—Each card program gets a program ID.
Promotion ID 194—Inside each program is multiple promotions. These promotions could be currently in use or reserved for future use. Each program can hold 40 promotions
Product List 198—Each promotion is mapped to a single or multiple UPC's. The system 100 can also identify products using PLU's or other category classifications. This list of products represents an all-inclusive list of items included in each unique Promotion ID 194.
Price Type 196—This numeric field is used to describe the discounting logic that the ECR will use for each promotion and its related products. The APL will contain a numeric value between 1 and 99. Example price types 196 are shown in the table of FIG. 2, along with an explanation of these values. The retailer ECR will have stored logic to identify each value with a corresponding price discounting protocol. Examples include:
   Discount percentages (%) with a dollar ($) cap on each promotion
   Discount dollar amounts ($) with a dollar cap on each promotion
   Free items with a quantity cap on each promotion

### S3 Platform Structure—Program Design

### How the S3 Platform Components 110, 130, 140, 170 Interact

Below is a sample program where all S3 cards 140 are loaded with a sample program. No configuration exists in this example for customized benefits by consumer. Rather, all changes to program design are handled through changes to the APL 124, 190. This example will be used to describe how the S3 card 140, APL 124, 190 and ECR logic 122 interact to create a fully functional S3 platform 100. The information stored on the card 140 and in the APL 124 in the ECT 110 at program launch is shown in FIG. 3.

Given this program configuration, consumers could use this card to get the following:
25% off various Pampers product offerings up to a $50 maximum discount amount
One free Pampers (Baby-Dry Diapers Size 2 Both Jumbo Pack—12-18 lbs.)

This is seen by comparing the program and promotion IDs 192, 194 on the APL 190 with the program and promotion IDs 148, 150 on the card 140. Those products listed in the first row of the APL 190 (assuming the IDs in the product list to be Pampers products) are associated with a program and promotion ID both being equal to 1, and a price type of 6. FIG. 1 shows that a price type of 6 is a percent discount with a dollar cap. The first row of the information on the card 140 shows that when the program and promotion ID are equal to 1, the promotion value is 25 and the quantity is 50. In light of the price type, that indicates a 25% discount, with a maximum discount in a benefit period being limited to 50 currency units (i.e., dollars).

How to Modify Cardholder Benefits after Program Launch

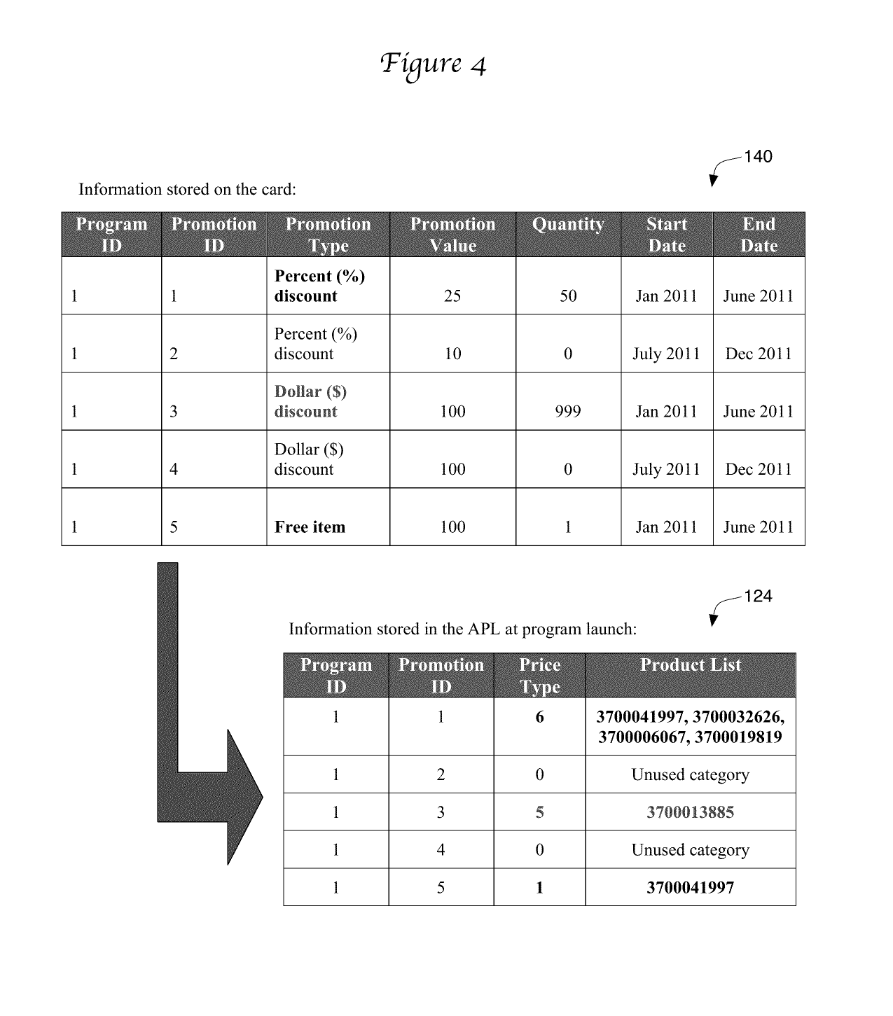

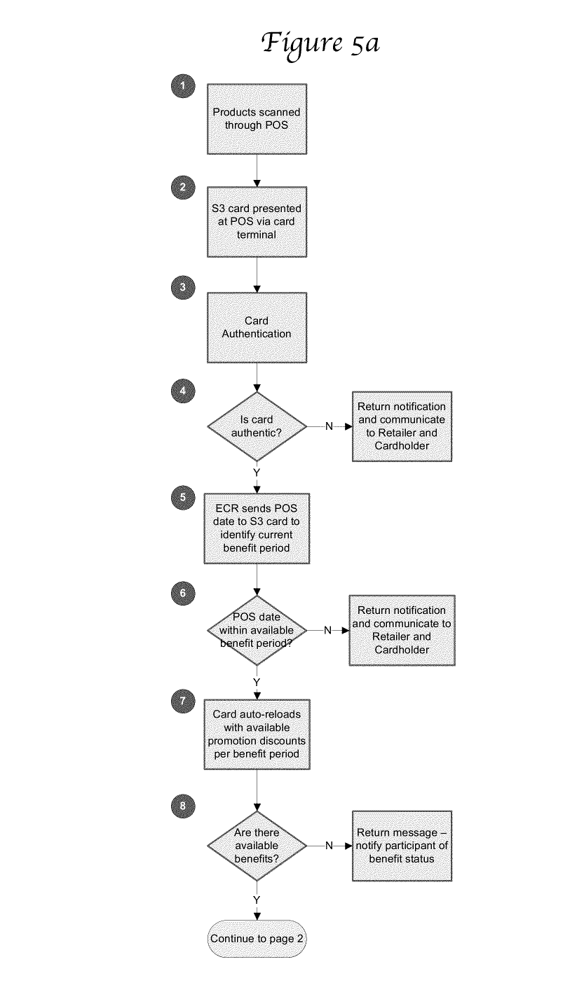

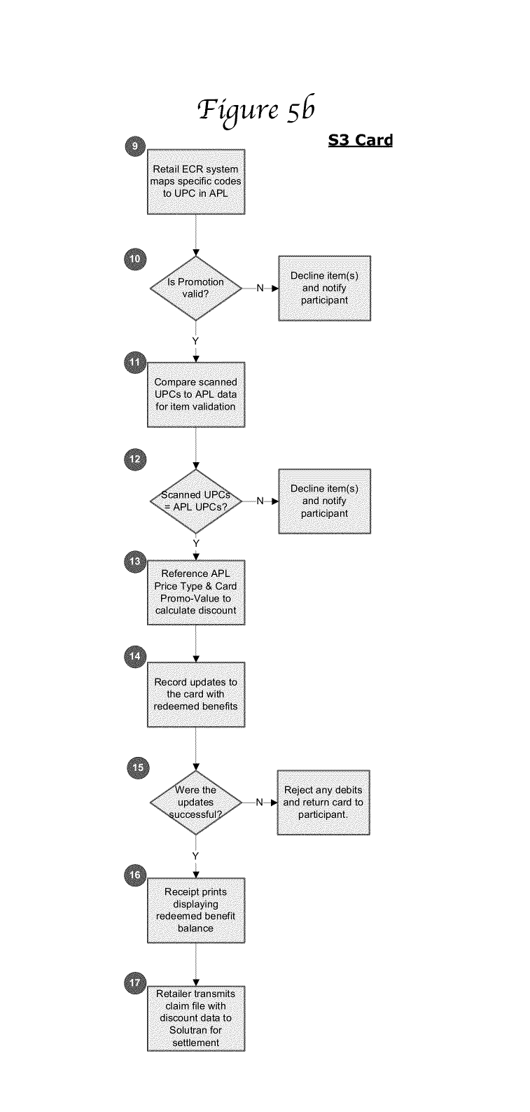

After the program is launched, the APL can be modified to change program benefits. The diagrams in FIG. 4 show the effect of adding UPC's to Promotion ID #3. In this example, the UPC added is a 50 oz. Tide product. No information is changed on the S3 Card.

Given this program configuration, consumers could use this card to get the following:
New promotion—$1.00 (or “100” cents as specified in the promotional value 158) off 50 oz. Tide
25% off various Pampers product offerings up to a $50 maximum discount amount
One free Pampers (Baby-Dry Diapers Size 2 Both Jumbo Pack—12-18 lbs.)

### Using the APL to Modify Program Structure

In one embodiment, the S3 system 100 can manage up to 99 different promotions. Obviously, variations of this invention could be structured to hold more than 99 programs. Each promotion can be structured to hold different discount types, quantities, start dates and end dates. This flexibility allows program managers to pre-configure a variety of programs that could be used in the future. These may never be used, but they are created to allow future program flexibility. Changes to the APL can immediately “turn on” these benefits for cardholders.

Below are a few promotional examples. For each example the corresponding card configuration APL structure is outlined. These examples show how the S3 Card can be modified over time to create interesting and flexible promotions.
1) Allowing one (1) free product every quarter.
   a. Card configuration—separate promotion for each quarter, value=100% discount, quantity—1.
   b. APL configuration—Appropriate UPC's loaded under current quarter's promotion ID. Multiple UPC's can be added, allowing consumers to “pick” their free product from an approved list.
2) Changing discount percentage from 10% to 25% on various products.
   a. Card configuration—separate promotion ID's for each discount rate, values=10% and 25% discount, quantities=999 for both.
   b. APL configuration—Appropriate UPC's loaded under each promotion ID. In this example, all UPC's would initially be loaded into the 10% discount promotion. At a future date, UPC's would be transferred to the 25% discount promotion ID.
3) Allowing “free gifts” to be selected by the consumer from a pre-determined list of products. In this example, allow three (3) free gifts for each new consumer.
   a. Card configuration—a separate promotion ID's is created, value=100% discount, quantity—3.
   b. APL configuration—Appropriate UPC's loaded under corresponding promotion ID. Multiple UPC's can be added, allowing consumers to “pick” their three free products from an approved list.

These examples are meant to describe the flexibility of the S3 platform. Many additional programs possibilities exist given the platform's flexible configuration.

### Promotional Distinctions

The above structure creates numerous benefits, including:
Generate revenue with brand loyalty and build long-term relationships between merchandisers/retailers and consumers.
Highly secure to reduce or eliminate fraud.
Next generation marketing intelligence captures trends, purchases, and needs.
Green solution reduces environmental footprints.
Smart card applications are controlled at the UPC specific level.
Turnkey market data drives sales.
Solutran offers full-range of services from collecting website information to retail payment delivery.
Detailed utilization trend reports.
Eliminate unnecessary costs with paper coupons and excessive packaging.
Solutran creates customized smart cards branded with your name and logo.
Streamlines the settlement process between the merchandiser and retailer.

Using the described embodiments, it is possible to create a fully branded, customized portal. We create a data-gathering portal that customizes query information with your name, company colors, and distinct personality. Each card application has its own screen, making it easy for merchandisers and retailers to access. Editing capabilities make it simple to change promotions and product offerings, with privacy secured at all times.

Another benefit is that consumers enter their data online. Consumers fill out a short form with brief, required information on the appropriate application screen. PIN numbers are given for identification purposes. Information is processed through Solutran channels and delivered to merchandisers and retailers for use in enhancing marketing efforts, communication, and building customer relationships.

In addition, accumulated benefits are viewable as long as the card is active. Consumers can log onto their accounts around the clock to check benefits and retrieve discount, prebate, and product information.

### Potential Uses

The S3 Card can be used to drive employee engagement in healthy living though incentives to eat better by developing a wellness card. By offering price discounts on healthy foods, employers can create a healthier, happier and more productive workforce. The S3 card will keep track of monthly benefit allowances and product discounts used. For example, a typical program may offer “25% off fruits and vegetables, up to a maximum benefit of $50/month.” Similarly, S3 allows product promotions for wellness-related products such as vitamins and diabetes test strips. The applications for a S3 wellness program are broad and unique.

Discount card can be developed whose benefits include i) generating revenue with brand loyalty—know who uses your discounts and what products they purchase; ii) eliminating paper coupon management, which saves labor for retailers, merchandisers, and consumers; iii) reducing fraud, risk of taking expired coupons, and loss from misplaced coupons and mailings; and iv) easy-to-read reports indicate redemption trends, retailer payments, and promotion performance.

Prebate card can be developed whose benefits include i) investing consumers in the purchase process; ii) creating buying incentives by providing a branded card with rebate money in hand; iii) reducing paper rebate fulfillment costs; tracking data redemption within days of usage; iv) increasing consumer satisfaction with up-front discounts; and v) creating future marketing to known buyers via market intelligence (after TV sales, you can promote monster cables, blue-ray, etc.).

Product sample card can be developed whose benefits include i) targeting your market with meticulous precision through consumer online registration website information; ii) more cost-effective compared to traditional product fulfillment packaging/shipping costs; iii) streamlining the product sample process by simplifying delivery through smart card use; iv) identifying future marketing opportunities based on buying trends; and v) leaving a lighter footprint on the environment by reducing waste.

Target market card can be developed whose benefits include i) the ability to build customized programs designed for each target market to drive sales; ii) uniquely branded cards for each promotion; iii) flexible card can structure promotions by product category or at the UPC level; iv) detailed reporting of consumer usage—by product, by store, and by day to help drive future promotions and sales; and v) supports channel partner programs on the same card.

### Method

The method for utilizing the S3 platform is shown in FIGS. 5a and 5b. Each step in this method is explained in the following chart.

| | |
|---|---|
| Step 1 | Products scanned and payment prompted to cardholder. |
| Step 2 | Card chip contains benefit period (use dates 154), |
| | program ID 148, promotion ID 150, quantity 152, and |
| | primary account number (PAN) 162, which includes the |
| | Solutran identification number for the approved product |
| | list (APL) 124. |
| | Additional unique Solutran S3 card features include: |
| | Price Type 156: Defines discount variables |
| | Promotion Value 158: Defines discount amounts |
| | Dynamic Reload Capacity 160: Allows for automatic |
| | benefit reload per calendar date |
| Step 3 | Authentication includes the following: |
| | Verify card as eligible S3 |
| | Read and verify PAN 162 to hot card list (HCL) 126 |
| | Authenticate participant to PIN |
| | Identify S3 specific APL 124 for further processing |
| Step 4 | Yes: Proceed to reference POS date |
| | No: the following must take place: |
| | System allows PIN to be entered up to three times before |
| | deactivation |
| | Retailer notifies cardholder if card is invalid |
| | Disable card if on HCL and direct cardholder to S3 portal |
| | Retailer reports activity in claim file |
| Step 5 | POS date is used to identify the current benefit period on |
| | the card to support S3 dynamic reload feature. |
| Step 6 | Yes: Proceed to card benefit auto-reload. |
| | No: No discounts available. Retailer reports activity to |
| | Solutran via claim file. |
| Step 7 | Current benefit period promotion discounts load to S3 |
| | card. This only occurs when dynamic reload is enabled on |
| | the S3 card and benefits are available for the given benefit |
| | period as identified by the POS date. |
| Step 8 | Yes: Extract benefit details including promotion specific |
| | codes and feed to the Retailer ECR system for APL |
| | processing. |
| | No: No discounts available. Retailer reports activity to |
| | Solutran via claim file. |
| Step 9 | ECR system takes benefit specific product codes and |
| | maps to Retailer APL to retrieve UPC, PLU, or any other |
| | product identifying detail. |
| Step 10 | Promotion validation criteria requires S3 card program |
| | ID, promotion ID, and price type to all match to the S3 APL. |
| | Yes: Proceed to discount UPC matching. |
| | No: No discounts available. Retailer reports activity to |
| | Solutran via claim file. |
| Step 11 | ECR system compares, at a UPC level, scanned items to |
| | find associated matches. |
| Step 12 | Yes: UPC match indicates benefits are available for |
| | scanned product UPCs. |
| | No: No discounts available. Retailer reports activity to |
| | Solutran via claim file. |
| Step 13 | ECR applies discount logic per the following: |
| | Reference Price Type to identify discount variables |
| | (values and limits). |
| | Reference Card Promo-Value to identify discount |
| | variable value. |
| | Reference Card Quantity to identify discount limit. |
| Step 14 | S3 card quantity decremented to reflect cardholder |
| | discounts received. |
| | A negative balance cannot be written to any card; |
| | therefore split tender is required to allow cardholder to |
| | settle balance. |
| Step 15 | Yes: Proceed to end transaction. |
| | No: Retailer records transaction activity, reports activity |
| | via claim file, nullifies discounts, and returns card to |
| | cardholder ensuring the current balance reflects balance |
| | as of the start of the transaction. |
| Step 16 | Receipt detail displays current transaction promotion |
| | discounts and available benefit balance for current benefit |
| | period. Cardholders can also access their personal benefit |
| | summary via S3 consumer portal and/or kiosks. |
| Step 17 | Retailer transmits claim file to Solutran for settlement. |

### Alternate Embodiment

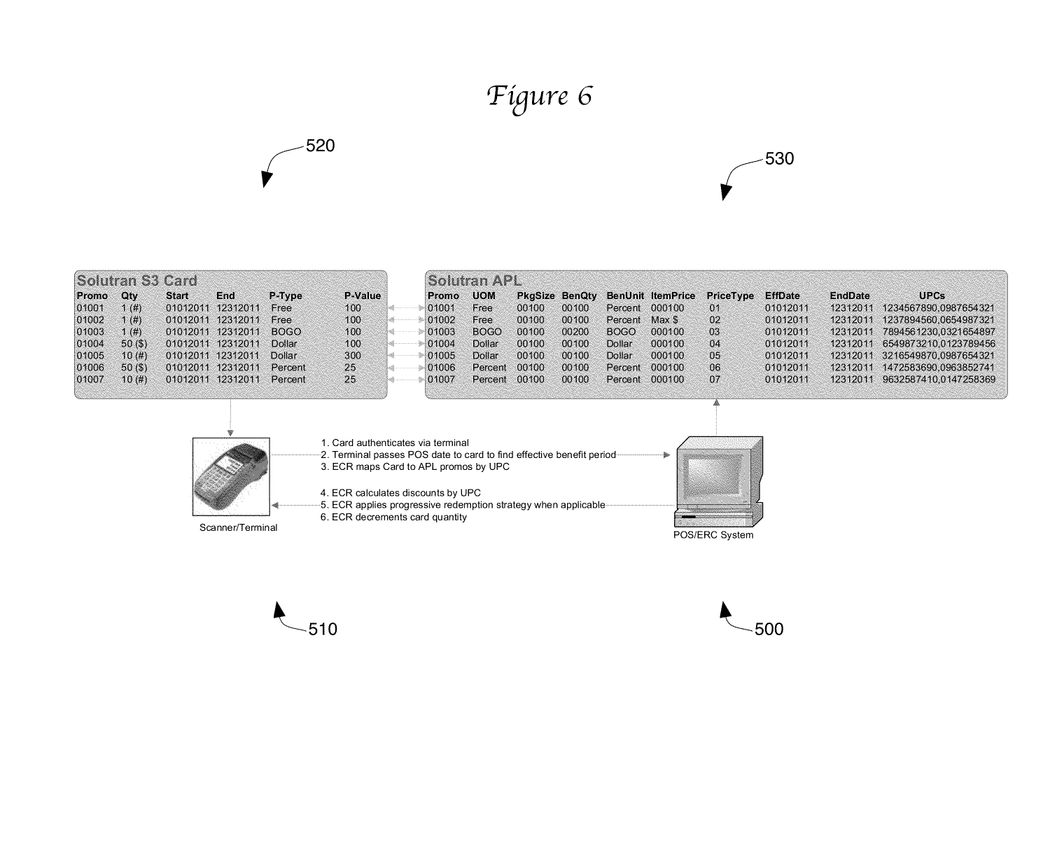

FIG. 6 shows another embodiment of the present invention with additional information data information. A point of sale/electronic cash register (POS/ECR) system 600 is provided to process items provided for purchase by a consumer. The POS/ECR system 600 is in electrical connection with a scanner/terminal 610. This scanner 610 is designed to read data off of a smart card 620. FIG. 6 shows the smart card 620 containing the following types of data 522: promo number, quantity 152, start time 154, end time 154, P-Type 156, and P-Value 158. The promo number includes the program ID 148 and the promotion ID 150 described above. The scanner 610 can read this card data off of the card 620, and provides the data to the POS/ECR system 600. The POS/ECR system 600 has access to an APL (or approved product list) 630. The access can be local or remote over a network. The APL 630 is updated regularly, and provides the POS/ECR system 600 with information on the currently running promotions and the qualifying products. The APL 530 includes the following types of data: promo number 192, 194, UOM, PkgSize, BenQty, BenUnit, ItemPrice, PriceType 196, EffDate, EndDate, and UPCs 198.

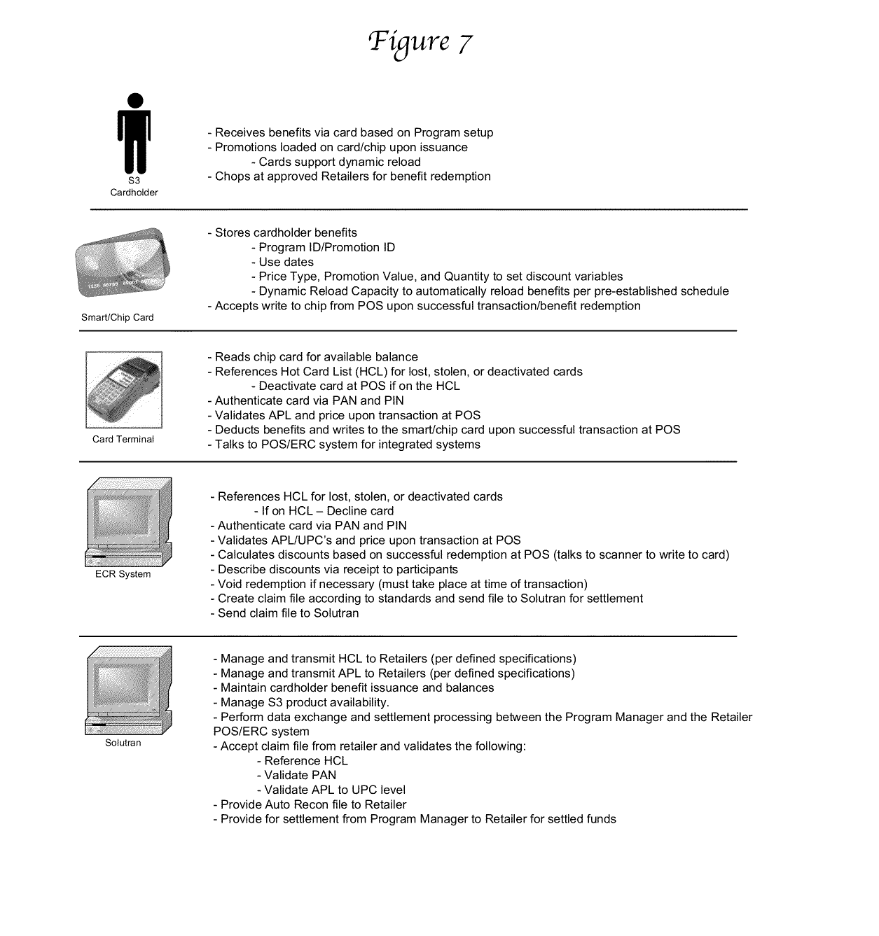

The various parties to the entities that will participate in the system and method of the present invention are shown in FIG. 7. As shown in that figure, cardholders or users receive the benefits of using the card. The card itself plays a role in storing benefit information and receiving updates from the POS/ECR system. The card terminal must communicate between the card and the POS/ECR system, and is responsible for authentication of the card. Authentication can be through PAN and PIN, and also can be made against a hot card list (HCL) of invalid cards that is provided from the central server. The card terminal deactivates invalid cards. The POS/ECR system holds the transaction logic, and utilizes the information obtained from the APL and the card to verify, complete, and record successful promotion redemptions. Finally, the Solutran central server is responsible for providing the HCL and APL to the POS/ECR system, validating the claim file received from the retailer, and for settling payment obligations between the various parties.

Comparison with WIC EBT

### Transaction Differences

Similar to the WIC EBT system, S3 uses a smart card payment platform to deliver food (and other) benefits to a target audience. The basic purpose of the WIC EBT platform is to deliver government benefits to a target population, WIC participants. As explained by the USDA, “the Special Supplemental Nutrition Program for Women, Infants, and Children—better known as the WIC Program—serves to safeguard the health of low-income women, infants, & children up to age 5 who are at nutritional risk by providing nutritious foods to supplement diets, information on healthy eating, and referrals to health care” (http://www.fns.usda.gov/wic/aboutwic/). The purpose of the S3 platform is to process transactions that are fundamentally different in nature. In particular, the S3 platform is designed to deliver a variety of consumer marketing and other initiatives. These initiatives may include the following:
Programs to deliver consumer product discounts to consumers
Programs to deliver free product samples to consumers
Programs to deliver buy-one-get-one-free product promotions to consumers
Programs to deliver medical plan benefits to insurance plan participants
Incentive programs designed to drive increased consumer engagement in wellness programs
Incentive programs designed to drive increased consumer use of specific products
Incentive programs designed to drive increased consumer engagement in healthy eating and healthy living programs
Incentive programs designed to deliver specific product discounts to consumers at the point-of-sale and replace product rebates with a product “prebate”
Loyalty programs to drive increased use of consumer products
Consumer marketing programs designed to replace paper coupons with smart-card digital coupons
Disaster relief benefit programs designed to deliver specific food or other product benefits to victims

Due to the many target applications of S3, the functionality of this platform is significantly enhanced as compared to WIC EBT. The largest difference relates to the type of discount transactions that can be applied through the smart card platform. The WIC EBT provides for free benefits, thus the only transaction type available is the ability to make free food items available to the cardholder. In contrast, S3 offers additional discounting options beyond free food items. In particular, the S3 platform allows for i) percentage (%) discounts made available on food items for cardholders; ii) dollar ($) discounts made available on food items for cardholders; and iii) buy-one-get-one-free discounts made available on food items for cardholders.

An additional S3 enhancement includes enhanced functionality relating to funding of benefits to the card. S3 allow multiple entities to support the funding of its programs whereas WIC EBT does not include this capability. An S3 program will include multiple promotions inside each program. S3 allows for multiple funders for each individual promotion. This compares to WIC EBT that only allows one funder per program.

### Structural Differences

S3 has modified the structure of various platform components to enable the enhanced functionality as compared to WIC EBT. A more detailed description of S3's platform design can be found below. The key differences of S3 as compared to WIC EBT relate to the functionality changes/additions to each of the following components:

S3 smart card compared to the WIC EBT smart card:
Additional data elements added to the S3 card—price type 156, promotion quantity 152, reload type 160
Automatic reloading capabilities added to the S3 card—S3 has the capability to auto-reload cardholder benefits once the benefit time period expires. A trigger received from POS will activate software on the S3 card to reload a new benefit period, according to pre-established business rules, and replenish benefits to the cardholder. This compares to WIC EBT that does not have this capability.

S3 Approved Product List (APL) 124, 190 compared to the WIC EBT APL:
Additional codes used in the APL to identify new price types 196
An additional record type to signify groupings of products. This record type will include new fields for department, class and subclass. Use of this record type will allow simplifications of product identification. Rather than identifying individual products by individual UPC's and PLU's (e.g. representing apples and bananas), product can be identified by department (e.g. produce).

S3 software installed at retailer POS/ECR System 110
Functionality added to trigger card's auto-reload—current date passed to card at transaction start
Functionality added to identify information off S3 card at transaction start
   Price type
   Promotion value
Functionality added to interpret price type field in the S3 APL
Functionality to compare and validate price type field in the APL vs. price type field on the S3 card. These values must match to allow processing of an S3 transaction.
Functionality added to interpret quantity field on S3 card based on the corresponding promotion price type field in the S3 APL
Functionality added to apply discounts to each purchase that corresponds to the following information—specific promotions available on S3 card, specific products available in the S3 APL, price (discount) types in the S3 APL, quantities on the S3 card for each promotion
Functionality added to disallow discounted transactions that exceed the Item Price field in the S3 APL

Of course, the system and methods described above are exemplary and are not the exclusive techniques for using the disclosed embodiments. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method of distributing promotions to a user comprising:
a) providing a smart card to a user, the smart card having the ability to track and modify quantities for different types of promotions, with each promotion identified by a promotion identifier;
b) providing a first list of promotions to a point of sale device, the first list of promotions identifying for each promotion the promotion identifier and the products that are part of the promotion;
c) at a point of sale, determining if a product is listed in the first list of promotions and if quantities for the promotion remain on the smart card; and
d) when the product is listed in the first list of promotions,
i) providing a promotional discount to a purchaser, the promotional discount being selected from a set of discounts comprising a percentage discount, a dollar discount, and a buy-one-get-one-free discount, and
ii) decrementing the quantity on the smart card.

2. The method of claim 1, wherein the quantities are measured in monetary units.

3. The method of claim 1, wherein the quantities are measured in units of products.

4. The method of claim 1, further comprising the step of providing a second list of promotions that replaces the first list of promotions.
